(19) United States
(12) Patent Application Publication
(10) Pub. No.: US 2026/0145058 A1
(43) Pub. Date: May 28, 2026

(54) Handheld Game Controller with User Input Device Configured for Use in a Space-Constrained Environment

(71) Applicant: Backbone Labs, Inc., Beaverton, OR (US)

(72) Inventors: Maneet Khaira, Vancouver, WA (US); Sydney Newton, Beaverton, OR (US); Zachary Scott, Palo Alto, CA (US); Evan Silverman, Emeryville, CA (US); Easton Kirchner, Beaverton, OR (US); Sean Missal, Beaverton, OR (US); Cory Newton, Redwood City, CA (US); Justin Satnick, Beaverton, OR (US); Patrick Chang, Beaverton, OR (US)

(73) Assignee: Backbone Labs, Inc., Beaverton, OR (US)

(21) Appl. No.: 18/962,755

(22) Filed: Nov. 27, 2024

(51) Int. Cl. A63F 13/24

(52) U.S. Cl. CPC A63F 13/24

(57) ABSTRACT

Space inside a handheld game controller can be limited, making it difficult to add a new or different user input device without increasing the overall size of the handheld game controller. The embodiments provided herein describe user input devices configured for use in such a space-constrained environment. In one embodiment, a cantilevered button is used when a component inside the handheld game controller is positioned in a path between the button and a switch. In another embodiment, an opening is made in a circuit board inside the handheld game controller to allow a joystick assembly to pass through the circuit board. Other embodiments are disclosed, and each embodiment can be used alone or in combination with other embodiments.

### BACKGROUND

A game controller is a device used to provide input to a video game, for example, to control an object or character in the video game. By way of illustration, the video game may be running on a computer, a specially-designed gaming system, a server or server cluster, or a mobile device. Some game controllers couple with a mobile device.

### BRIEF DESCRIPTION OF THE DRAWINGS

FIG. 1 is a front view of handheld game controller of an embodiment.

FIG. 2 is a rear view of handheld game controller of an embodiment.

FIG. 3 is a front view of handheld game controller of an embodiment being used with a mobile device.

FIG. 4 is an internal view of a handheld game controller of an embodiment.

FIG. 5 is a perspective view of an alternate handheld game controller of an embodiment.

FIG. 6 is an internal view of a handheld game controller of an embodiment showing rear buttons.

FIG. 7 is a cross-sectional view of a handle of a handheld game controller of an embodiment.

FIG. 8 is another cross-sectional view of a handle of a handheld game controller of an embodiment.

FIG. 9 is a perspective internal view of a handle of a handheld game controller of an embodiment.

FIGS. 10A and 10B are top internal views of a handheld game controller of an embodiment.

FIG. 11 is a cross-sectional view of the handheld game controller of FIG. 10B taken along line 11-11.

FIG. 12 is an expanded view of a portion of the handheld game controller shown in FIG. 11.

FIG. 13 is a cross-sectional view of the handheld game controller of FIG. 10B taken along line 13-13.

FIG. 14 is a cross-sectional view of the handheld game controller of FIG. 10B taken along line 14-14.

FIG. 15 is a cross-sectional view of a right handle of a handheld game controller of an embodiment.

FIG. 16 is another cross-sectional view of a right handle of a handheld game controller of an embodiment.

FIG. 17 is a cross-sectional view of a left handle of a handheld game controller of an embodiment.

FIG. 18 is a cross-sectional perspective view of a left handle of a handheld game controller of an embodiment.

FIG. 19 is a perspective internal view of a handle of a handheld game controller of an embodiment.

FIG. 20 is another perspective internal view of a handle of a handheld game controller of an embodiment.

FIG. 21 is an internal view of a handle of a handheld game controller of an embodiment.

FIG. 22 is a perspective view of a rear button of an embodiment.

FIG. 23 is a perspective view of a handheld game controller of an embodiment.

FIG. 24 is a cross-sectional view of a joystick assembly of a handheld game controller of an embodiment.

FIG. 25 is a top view of a component of a handle of a handheld game controller of an embodiment.

FIG. 26 is a cross-sectional view of a joystick assembly of a handheld game controller of an embodiment.

FIG. 27 is a top view of a component of a handle of a handheld game controller of an embodiment.

FIG. 28 is a cross-sectional view of the joystick assembly of FIG. 27 taken along line 28-28.

### DETAILED DESCRIPTION

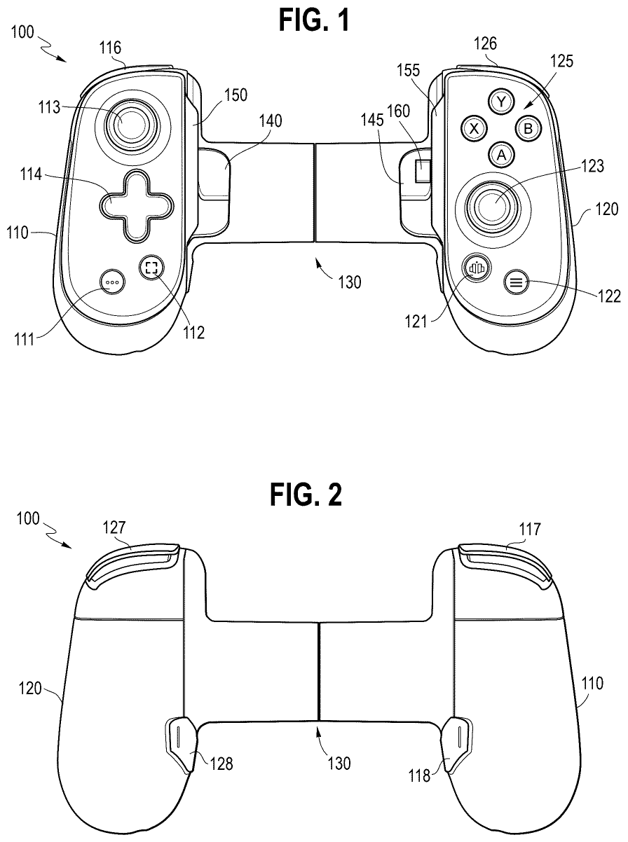

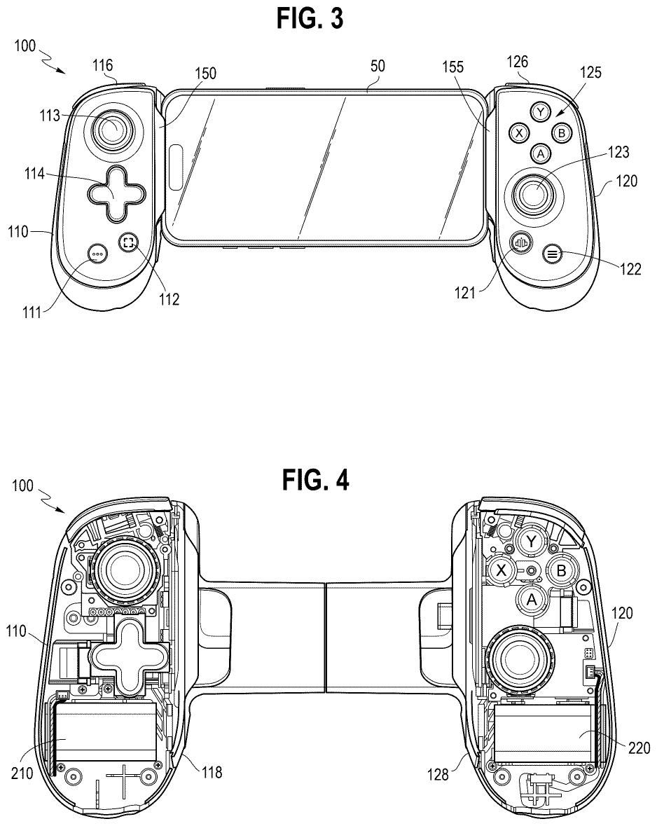

Turning now to the drawings, FIGS. 1 and 2 are front and rear views of a handheld game controller 100 of an embodiment. As shown in FIG. 1, the handheld game controller 100 of this embodiment comprises a first (left) handle 110, a second (right) handle 120, and a bridge 130 coupling the first and second handles 110, 120. The handheld game controller 100 also comprises support pads 140, 145 and overhang portions 150, 155. The support pads 140, 145 (which can be fixed to the handheld game controller 100 or removable) can be made from a compliant material to cushion and grip edges of a mobile device 50 placed between the first and second handles 110, 120 (see FIG. 3). As also shown in FIG. 3, the overhang portions 150, 155 can contact a portion of the top surface of the mobile device 50 to help further secure the mobile device 50. Examples of overhang portions and support pads can be found in U.S. patent application Ser. No. 18/777,919, filed Jul. 19, 2024, and U.S. patent application Ser. No. 18/805,902, filed Aug. 15, 2024, both of which are hereby incorporated by reference. It should be noted that the overhang portions and support pads described in those applications are merely examples and are not required for use with these embodiments. Further, other types of overhang portions and/or support pads can be used.

Referring back to FIG. 1, the handheld game controller 100 of this embodiment comprises an electrical connector 160 (e.g., a USB-C connector) that is configured to physically connect with a corresponding electrical connector on the mobile device 50 to provide transfer of data and/or power. It should be noted that in other embodiments, an electrical connector is not used, and a wireless device in the handheld game controller 100 (e.g., a magnetic connector in the bridge 130 or a Bluetooth chip in the game controller) is used to provide wireless transfer of data and/or power. In other embodiments, the electrical connector 160 is still used when the handheld game controller 100 has a wireless device in the game controller. For example, in one embodiment, the magnetic connector can be used simply to magnetically retain the mobile device 50 and/or to position the mobile device 50 to align its electrical connector with the electrical connector on the handheld game controller 100. In another example, the magnetic connector is also used to provide wireless charging but not transfer of data between the handheld game controller 100 and the mobile device 50 when that functionality is performed by the electrical connector 160. Examples of game controllers with magnetic connectors can be found in U.S. patent application Ser. Nos. 18/369,000 and 18/369,025, both filed Sep. 15, 2023, which are hereby incorporated by reference. It should be noted that the game controllers with magnetic connectors described in those applications are merely examples and are not required for use with these embodiments. Further, other types of game controllers and/or magnetic connectors can be used.

In example embodiments, the wireless connectivity and wired connectivity can be used simultaneously or one at a time. In a simultaneous connectivity experience, a wired connected device can be used for one purpose, where the wireless connected device can be used for another purpose. As an example, if a mobile device is connected by wire through the game controller's connector, an application running on the mobile device can control various aspects of the game controller while supporting wireless connections to other devices (e.g., a console, a speaker, a television, etc.). The application running on the mobile device can provide functionality such as switching on pairing via Bluetooth, applying different customization profiles, or even using hardware of the mobile device (e.g., haptics, motion, sound, or screen imagery) to enhance the game controller experience.

In this embodiment, the first and second handles 110, 120 are in sliding engagement with the bridge 130. In operation, a user pulls the first and second handles 110, 120 apart from a default, compact position (in which the first and second handles 110, 120 have a minimum span between them) to create a span between the first and second handles 110, 120 that is longer than the length of the mobile device 50. This position will sometimes be referred to herein as the extended position. This allows the mobile device 50 to be positioned between the first and second handles 110, 120. When in this position, the user can connect the electrical connector on the mobile device 50 with the electrical connector on the handheld game controller 100. After the connection is made, the user allows the first and second handles 110, 120 to move together until the inside edges of the first and second handles 110, 120 contact the edges of the mobile device 50 to secure the mobile device 50 in place, as shown in FIG. 3. This position will sometimes be referred to herein as the retracted position. In this example, the handheld game controller 100 comprises a spring or other mechanism to bias the first and second handles 110, 120 toward the retracted position. However, in other implementations, the user can be required to push the first and second handles 110, 120 toward the retracted position. Also, the handheld game controller 100 can comprise a stay-open and/or stay-closed latch mechanism to temporarily lock the first and second handles 110, 120 in various position(s). Also, instead of manually moving the first and second handles 110, 120, a user can interact with a physical actuator on the handheld game controller 100 (and/or a virtual actuator displayed on the mobile device 50) to cause movement of the first and second handles 110, 120.

Because the described device includes a battery and supports pass-through charging, the device may (through software or other means) identify preferences for charging. For example, the wired connection may be the preferred means to transfer power by default. The wired connection (e.g. USB-C) could provide power to the system to power the device with or without charging the battery, or it could provide power from the battery to the mobile device, or it could charge the battery. In certain embodiments, the game controller and mobile device can be charged in parallel, and some power can be siphoned off to power the game controller while still charging the mobile device at a reasonable rate. Optionally, the phone itself could transfer power to charge the game controller's battery. Software may be used to prioritize different configurations at different intervals or balance power supply based on previously predetermined thresholds. Examples of various power management techniques can be found in U.S. patent application Ser. Nos. 18/369,000 and 18/369,025, both filed Sep. 15, 2023, which are hereby incorporated by reference. It should be noted that the power management techniques described in those applications are merely examples and are not required for use with these embodiments. Further, other types of power management techniques can be used.

The first and second handles 110, 120 can be movable in any suitable way. In one example implementation, first and second linear racks are coupled to the first and second handles 110, 120, respectively, and are in sliding engagement with the bridge 130. The first and second linear racks can be located partly in the first and second handles 110, 120, respectively, and partly in the bridge 130. A pinion can be in contact with the first and second linear racks and configured to rotate relative to the bridge 130 as the first and second linear racks are translated relative to the pinion. Of course, this is just an example, and other mechanisms are possible. Also, instead of the first and second handles 110, 120 moving linearly, the first and second handles 110, 120 can have different degrees of motion, such as when the first and second handles 110, 120 are foldable.

As shown in FIGS. 1-3, in this embodiment, the first and second handles 110, 120 comprise a plurality of user input devices (e.g., control surfaces) that a user can manipulate to provide input to a video game (or other application) being run by a computing device, such as the mobile device 50 (e.g., a mobile phone or tablet) or any connected device (e.g., using wireless connection or a wired connection). In this example, the user input devices take the form of buttons 111, 112, 121, 122; joysticks 113, 123; a directional pad (D-pad) 114, four “face buttons” (e.g., A, B, X, Y buttons) 125; bumper (shoulder) buttons (e.g., L1, R1) buttons 116, 126; trigger buttons (e.g., L2, R2) 117, 127; and rear buttons 118, 128. The user input devices can be made of any suitable material. For example, in one embodiment, the buttons 111, 112, 121, 122; D-pad 114, and four “face buttons” 125 are membrane buttons, which are quieter and have a softer press compared to traditional buttons.

It should be noted that the user input devices shown in these figures are merely examples, that more or fewer user input devices can be used, and that different types of user input devices can be used (such as, but not limited to, a knob, a wheel, a slider, a dial, a touch-sensitive screen/pad, a microphone for audio input (e.g., to capture a voice command or sound), a camera for video input (e.g., to capture a hand or facial gesture), etc.).

It should also be noted that while the user input devices described below are illustrated with reference to the game controller design shown in FIGS. 1 and 2 and described above, the user input devices can be used on other types of game controllers, such as, but not limited to, game controllers that use a different mechanism to couple with a mobile device (e.g., game controllers with foldable handles or non-movable handles integrated into the game controller) and game controllers that do not couple with a mobile device (e.g., game controllers for a traditional game console).

In one embodiment, the handheld game controller 100 is a compact, portable device designed to have a certain form factor to make it convenient for users to take and use on-the-go while still retaining all of the functionality and purposeful design to enable an elevated gaming experience. As shown in the internal view of the handheld game controller 100 in FIG. 4, the handheld game controller 100 of this embodiment contains a relatively-large number of internal components, and available “real estate” inside the handheld game controller 100 is at a premium. This can lead to several challenges in adding components while maintaining a desired overall size of the handheld game controller 100. Take, for example, the rear buttons 118, 128. (While the rear buttons 118, 128 are used in this example, it should be understood that the space-saving improvements described herein can be used with any suitable user input device on the game controller 100.) A typical button could be designed with an internal protrusion that is perpendicular to the face of the button and positioned adjacent to an internal switch. When the user presses the button, the direction of force applied to the button by the user would be co-axial with a force applied by the protrusion to contact the switch. As such, this design requires a clear path between the button and the internal switch. However, because of the limited “real estate” inside the handles 110, 120, one or more internal components inside the handles 110, 120 may be blocking this path. For example, in the embodiment shown in FIG. 4, batteries 210, 220 positioned near the rear buttons 118, 128 in the handles 110, 120 obstruct such a path from the rear buttons 118, 128.

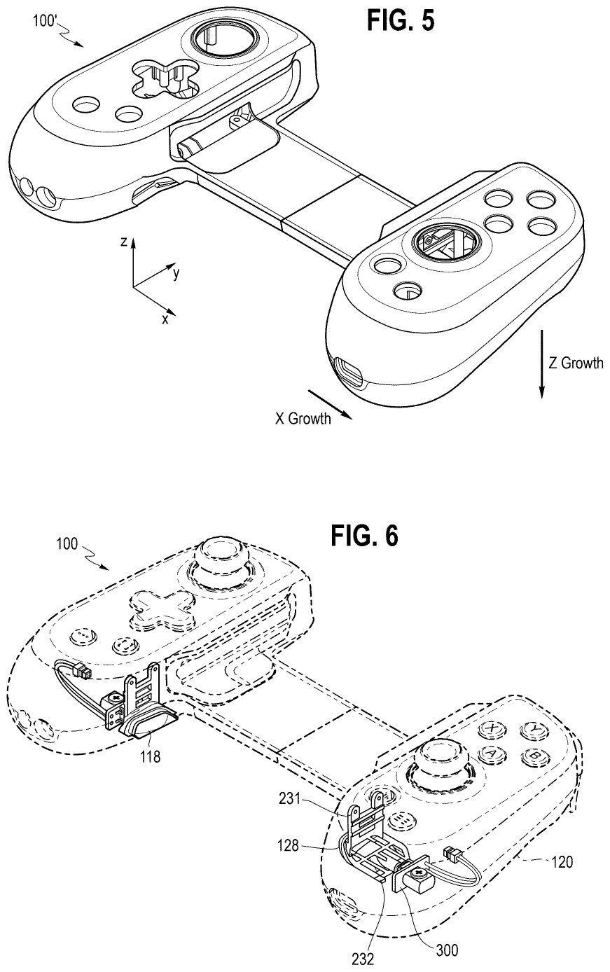

One way to address this problem is to increase the size of the handles 110, 120 to create more “real estate” and move the batteries farther away from the rear buttons, thus creating a clear path between the rear buttons and their internal switches to allow for the co-axial application of force described above. However, as illustrated in FIG. 5, the resulting size of the handles of such a game controller 100′ would increase in the X direction, which, as shown in the legend in FIG. 5, is the direction defined between the first and second handles 110, 120. (As will be explained in more detail below, FIG. 4 also shows that the size of the handles in the Z direction would increase if a taller joystick were used in the handheld game controller 100′.) This increased size may not be desirable, as it can adversely affect the portability of the handheld game controller 100′ (e.g., the handheld game controller 100′ may be too bulky to carry in a pocket or small bag), as well as the usability of the handheld game controller 100′ (e.g., the handles of the handheld game controller 100′ may be too big to fit comfortably in a user's hands).

The embodiments described herein provide another way to address this problem without increasing the size of the handheld game controller 100. More specifically, as shown in FIG. 6, the rear button 128 of the second handle 120 in this embodiment comprises an L-shaped cantilevered element. (“L-shaped” can refer to an angle of 90 degrees or about 90 degree (plus or minus), or it can refer to an even larger angle up to, but not including, 180 degrees.) The rear button 118 of the first handle 110 of this embodiment is similarly structured. So, while the following example will be described with respect to the rear button 128 on the second handle 120, it should be understood that the rear button 118 on the first handle 110 can operate in a similar way. However, in other embodiments, the two rear buttons 118, 128 are configured differently from one another. It should also be noted that this cantilevered design can be used with other types of buttons (i.e., not just the rear button(s)) and/or other types of user input devices (i.e., not just buttons).

In this embodiment, the rear button 128 is cantilevered, meaning that only its first end 231 is supported and its second end 232 is free to move. The first end 231 can be “supported” when the first end 231 is “fixed” (i.e., prevented from all six degrees of movement) or when the first end 231 is “pinned” (i.e., pivotable but otherwise prevented from movement). In this embodiment, the first end 231 is fixed to a component (e.g., an internal body structure) inside the second handle 120 via screws 320 (although any suitable type of attachment mechanism (e.g., adhesive, welding, etc.) can be used). Embodiments in which the first end 231 is pinned (as opposed to fixed) are described later in this document.

As shown in FIGS. 6-9, in this embodiment, the second end 232 of the rear button 128 is positioned inside the second handle 120 adjacent to, but not in contact with, a switch 300 when the rear button 128 is in a non-depressed position. (In another embodiment, the second end 232 of the rear button 128 is in contact with, but not pressing, the switch 300 when the rear button 128 is in a non-depressed position.) In this example, the switch 300 is a mechanical switch that is activated by physical contact with the second end 232 of the rear button 128. In other embodiments, the switch is a Hall-effect switch that is activated in response to a certain relative distance between the second end 232 of the rear button 128 and the switch 300, where the second end 232 of the rear button 128 does not have physical contact with the switch 300. Other types of switches can be used.

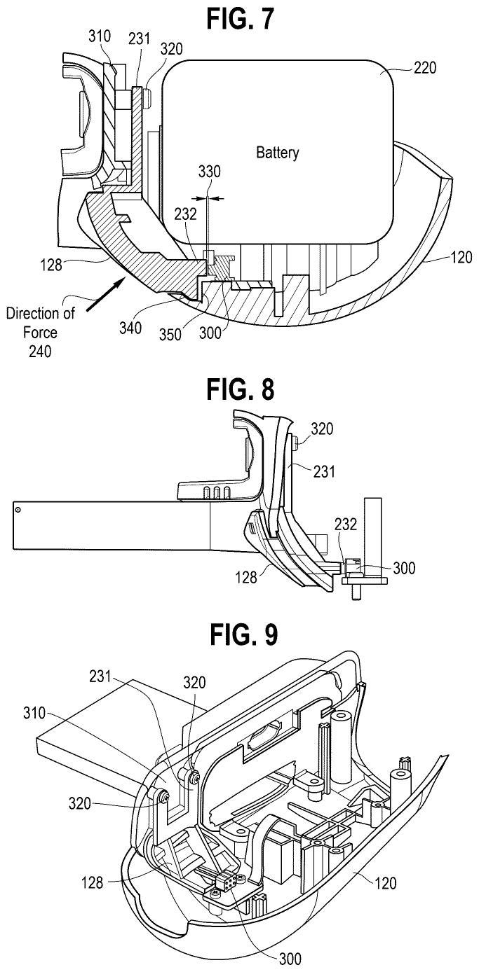

As illustrated in FIG. 7, the positioning of the battery 220 in this design prevents use of a button that applies the user's direction of force 240 co-axially with a direction of force needed to contact the switch 300. The cantilevered L-shaped design of the rear button 128 in this embodiment addresses this situation by accounting for the limited space and geometry available inside the second handle 120. Here, the rear button 128 is made of a material that allows the rear button 128 to deform upon application of user force (and, optionally, that allows the rear button 128 to restore itself to its starting position after the user force is removed). In one example implementation, the rear button 128 is made of a blend of polycarbonate and acrylonitrile butadiene styrene (PC-ABS).

The rear button 128 comprises a user contact region exposed outside of the second handle 120 that the user presses to apply the user force to the rear button 128. The user contact region can be integrated with other structures of the rear button 128 or can be coupled with (e.g., affixed) to other structures of the rear button 128. The phrase “the rear button comprising a user contact region” is intended to cover either configuration.

In operation, when the user presses the user contact region of the rear button 128, the first end 231, being fixed, does not move in response to this force. However, at least some of the remainder (the “arm”) of the rear button 128 flexes and deforms in response to this force, forming a curve that is more aggressive the farther the user pushes the rear button 128. This deformation causes the second end 232 of the rear button 128 to move in contact with the switch 300. As shown in FIG. 7, in this embodiment, an internal portion 350 of the second handle 120 serves as a hard stop to prevent further movement of the second end 232 of the rear button 128 after the second end 232 is in contact with the switch 300.

The rear button 128 can also be configured to restore itself to its non-deformed position when the user releases the rear button 128. In this way, the rear button 128 acts as a cantilever spring, with the restorative spring force moving the second end 232 of the rear button 118 away from (and out of contact with) the switch 300 when the user releases the rear button 128. As shown in FIG. 7, in this embodiment, when rear button 128 moves back to its starting position, there is zero gap 340 between the user contact portion of the rear button 128 and the external housing of the second handle 120, which avoids possible rattle caused by the rear button 128 and avoids an exposure point to the inside of the game controller 100.

Any suitable type of material can be used to provide the rear button 128 with a desired deformation and/or restorative spring force, as well as to satisfy any other engineering and/or user experience constraint. In this way, the material can be considered a tunable element of the design. To the extent additional force is needed to move the rear button 128 to its starting position, a spring can be added to apply such additional force (assuming space is available inside the second handle 120 for a spring). Additionally, the switch 300 itself may have some amount of spring force to help restore the rear button 128 back to its starting position after user force is removed from the rear button 128. However, such spring force may be relatively small, in which case the spring force characteristics of the material of the rear button 128 may be the dominant force to restore the rear button 128 back to its starting position after user force is removed from the rear button 128.

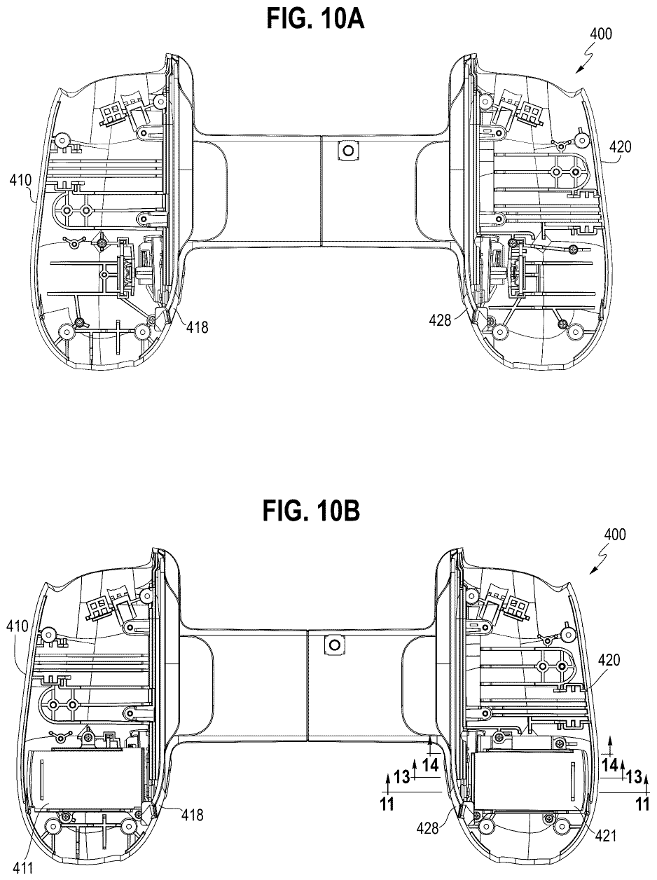

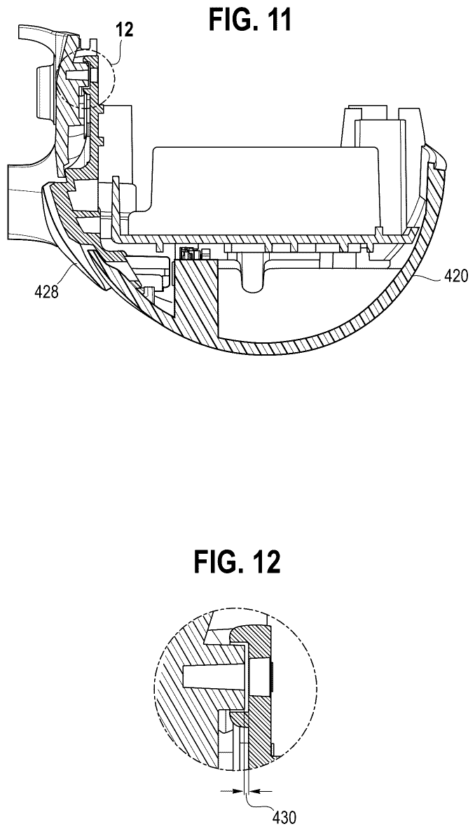

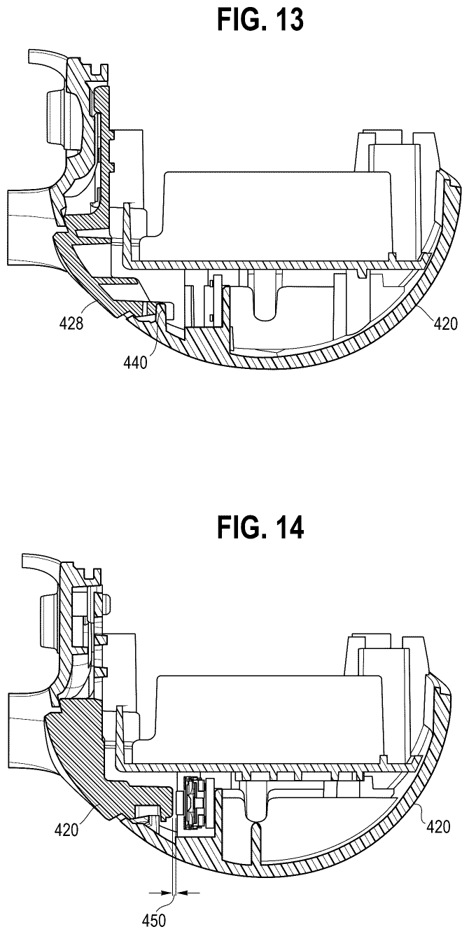

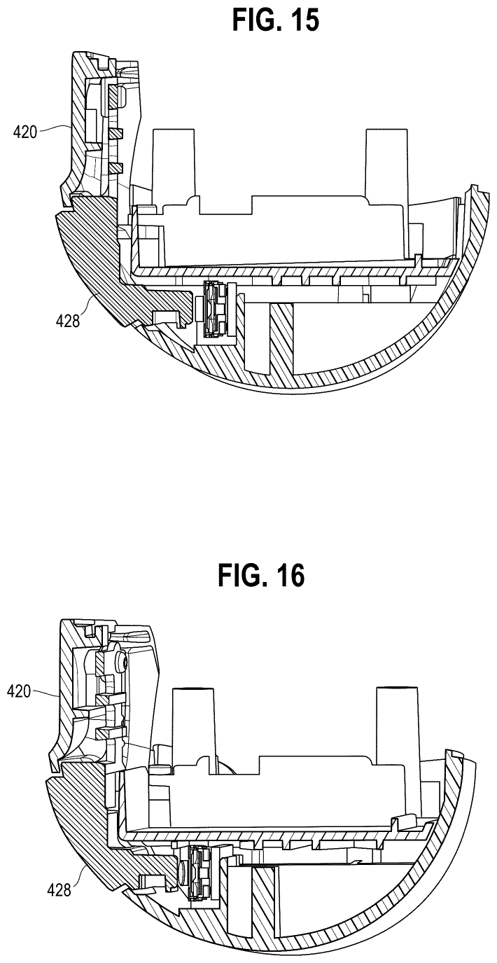

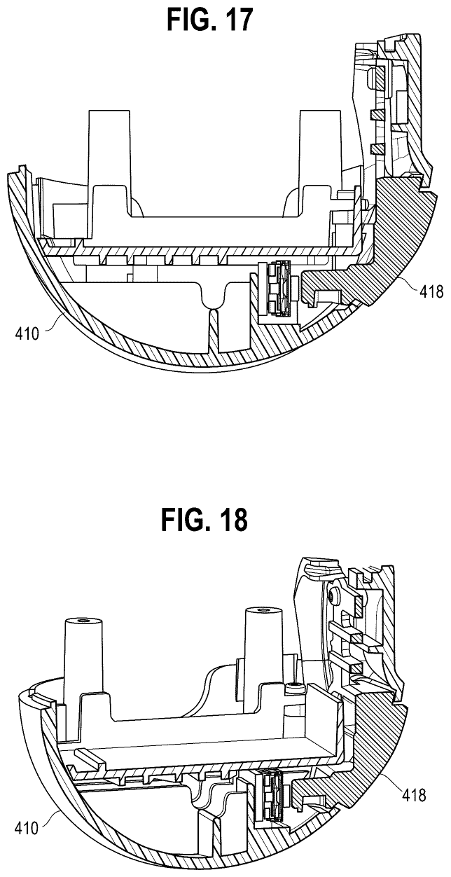

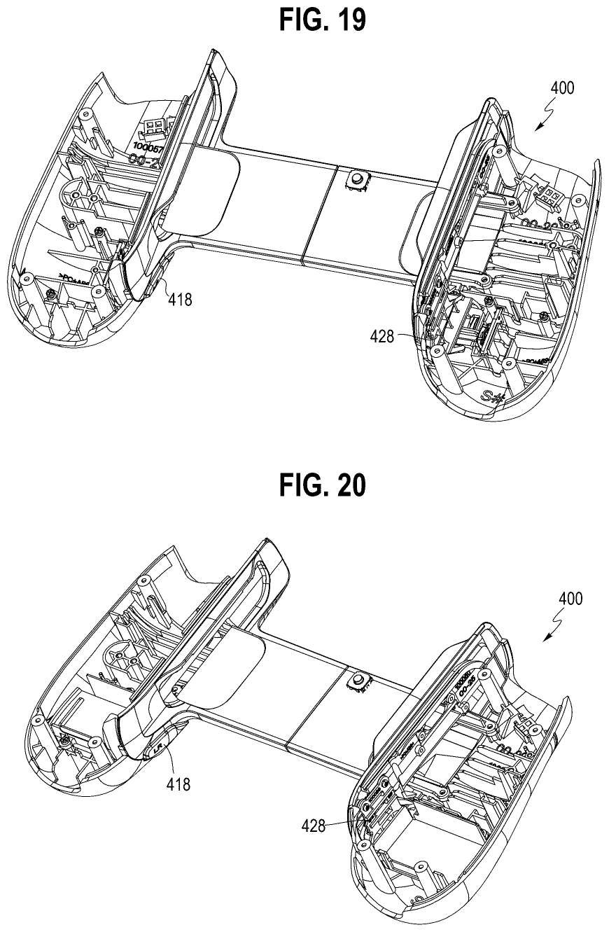

It should be noted that the design shown in the figures described above is just one example configuration and that other configurations can be used, such as, but not limited to, the examples shown in FIGS. 10A-20. FIGS. 10A and 10B are top internal views of a bottom portion of a handheld game controller 400 of an embodiment. FIG. 10A shows the bottom portion of the handheld game controller 400 without batteries 411, 412 in the left and right handles 410, 421, and FIG. 10B is a view with the batteries 411, 412 included. FIG. 11 is a cross-sectional view taken along lines 11-11 in FIG. 10B, and FIG. 12 is an expanded view of portion 12 in FIG. 11. As shown in FIG. 12, there is a gap 430 to preload the rear button 428. FIG. 13 is a cross-sectional view taken along line 13-13 in FIG. 10B and shows a hardstack 440 that preloads the rear button 428 with a preloaded gap. FIG. 14 is a cross-sectional view taken along line 14-14 in FIG. 10B and shows a gap 450 to the tact switch for tolerance stacks, which does not degrade a user experience due to the preload. FIGS. 15 and 16 are cross-sectional views of the right handle 420, and FIGS. 17 and 18 are cross-sectional views of the left handle 420. Further, FIGS. 19 and 20 are additional perspective internal views of the bottom portion of the handheld game controller 400 of this embodiment.

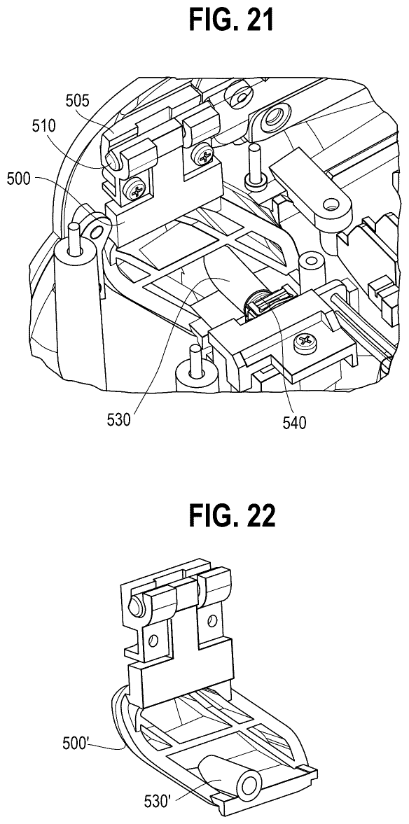

There are many other alternatives that can be used with these embodiments. For example, as noted above, instead of the first end of the rear button being “fixed” (i.e., prevented from all six degrees of movement), the first end of the rear button can be “pinned” (i.e., pivotable but otherwise prevented from moving). This alternative is shown in FIGS. 21 and 22. As shown in these figures, in this embodiment, the first end 505 of the rear button 510 is rotatable about a pin 510 in the game controller. When a user pushes the rear button 510, the first end 505 rotates about the pin 510, which causes the second end 520 of the rear button 510 to contact a switch 540. In some embodiments, the switch 540 may have enough restorative force to move the rear button 510 back to its original position after the user releases the rear button 510. In other embodiments, a spring (not shown) is used to provide, at least in part, the restorative force to the rear button 510. The spring can be, for example, a conical spring or a torsion spring wrapped around the pivot point. In one example implementation, the pivot point is shifted about one millimeter in the Z direction as compared to the fixed design described above. Also, the arm of the rear button 510 can be strengthened to increase torsional stiffness without impacting actuation force. The pivot arm can provide about a 3.5 millimeter actuation shift. Further, the button pre-load to the housing can rely on the switch pre-load. Other configurations are possible. For example, in the alternative shown in FIG. 22, the second end 530′ of the rear button 500′ is in a different position to accommodate a different location of the switch.

Another space constraint concerns the joystick of the game controller. Game controllers for use with mobile devices are sometimes equipped with smaller-size joysticks to make the game controllers compact and portable. However, some users may prefer the feel of a full-size joystick. In one example embodiment, a smaller-size joystick is a joystick characterized by a tilt angle of about 17 degrees, and a full-size joystick is a joystick characterized by a tilt angle of about 19-22 degrees. Also, a full-size joystick can utilize a different architecture than a smaller-size joystick. For example, a full-size joystick can use circular radial potentiometers, whereas a smaller-size joystick can use linear wipers.

As discussed above in conjunction with FIG. 4, the use of a taller, fuller-size joystick may require the size of the handles in the Z direction to increase to accommodate the larger parts of the joystick assembly inside the handle. However, this increased size may not be desirable, as it can adversely affect the portability of the game controller by making the game controller too bulky. The embodiments described herein can be used to address this situation. In one example implementation, the total thumbstick height in the Z direction using these embodiments is about 13.77 mm.

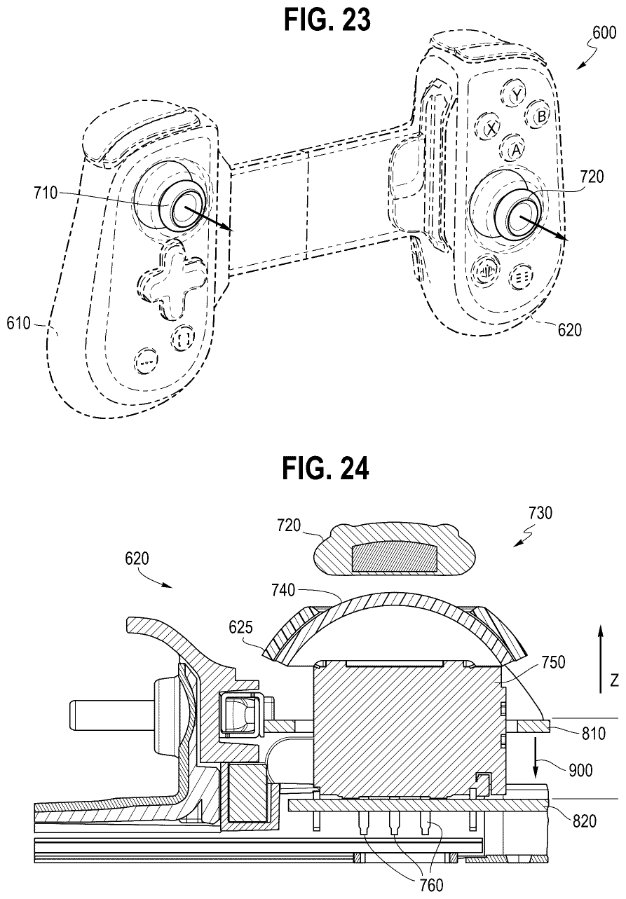

Turning again to the drawings, FIG. 23 illustrates a handheld game controller 600 of an embodiment having first and second joysticks 710, 720 on its first and second handles 610, 620. These joysticks are more full-sized compared to the joysticks 113, 123 of the game controller 100 shown in FIG. 1. FIG. 24 is a cross-sectional view of a joystick assembly 730 used in the second handle 620 of this game controller 600. A similar configuration can be used in the first handle 610. As shown in FIG. 24, the joystick assembly 730 in this example comprises a movable stick (the joystick) 720, a housing 750 housing circuitry configured to translate movement of the movable stick 720 to an electrical signal, and one or more electrical contacts 760 configured to convey the electrical signal. In this embodiment, the joystick assembly 730 also comprises skirting 740 that moves along with the movable stick 720 and is positioned adjacent to an outer housing portion 625 of the second handle 620. The skirting 740 protects against dust and other contaminants from entering inside the second handle 620.

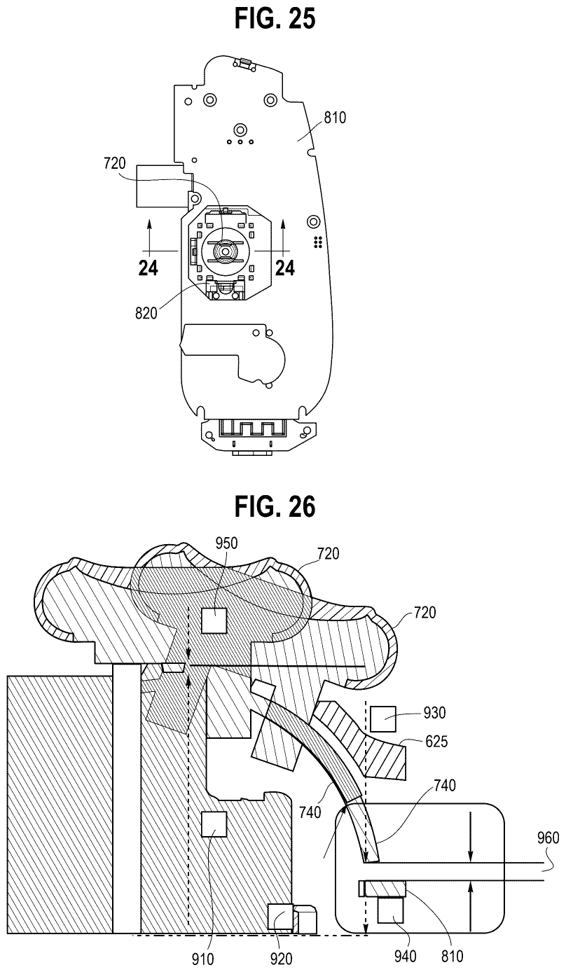

FIGS. 24 and 25 show first and second circuit boards 810, 820 inside the second handle 620. The first circuit board 810 is above the second circuit board 820 by a distance denoted by reference number 900. That is, the first circuit board 810 is higher in the Z direction (closer to the top of the second handle 620) than the second circuit board 820. If the connectors 760 of the joystick assembly 730 were mounted to the first circuit board 810, the second handle 620 may need to have a greater height (in the Z direction) to accommodate the joystick assembly 730. As mentioned above, increasing the handle height may be undesirable. So, in this embodiment, an opening (hole) is made in the first circuit board 810 through which the joystick assembly 730 passes (in this example, the circuity housing 750 is positioned within the opening of the first circuit board 810, but other components of the joystick assembly 730 can be positioned in the opening instead). With this configuration, the connectors 760 of the joystick assembly 730 can be connected to the lower second circuit board 820 instead of the higher first circuit board 810, thereby avoiding the need to increase the height of the handle to accommodate the joystick assembly 730.

With reference to FIG. 26, in this embodiment, the joystick height 910 is 18.98 mm, the printed circuit board datum parallelism 920 is 0, the joystick's cap height 930 is 12.041 mm, the printed circuit board datum 940 is 5.9 mm, and cap dimension 950 is 0.4 mm. Of course, this is just an example, and other suitable dimensions can be used.

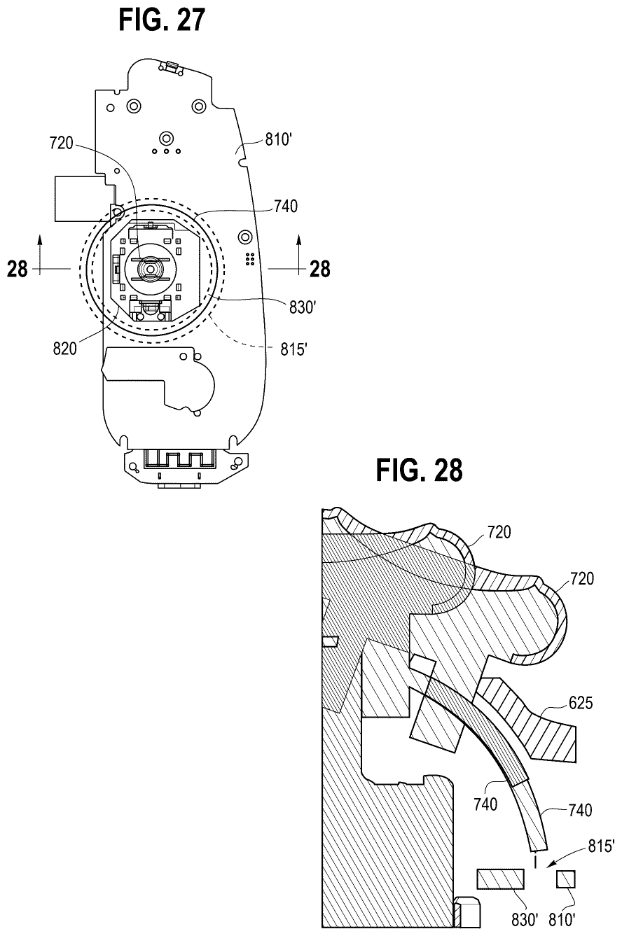

As also shown in FIG. 26, in this embodiment, the joystick assembly 730 is positioned such that a gap 960 exists between the skirting 740 and the first circuit board 810 when the joystick 720 is moved to its limit (“full tilt”). However, in another embodiment (shown in FIGS. 27 and 28), the first circuit board 810′ comprises as second opening 815′ through which the skirting 740 passes when the joystick 720 is to its full tilt. In this embodiment, there is another portion 830′ of the first circuit board 810′ under the skirting 740, which provide additional “real estate” for additional circuity on the first circuit board 810′.

It is intended that the foregoing detailed description be understood as an illustration of selected forms that the invention can take and not as a definition of the invention. It is the following claims, including all equivalents, which are intended to define the scope of the claimed invention. Finally, it should be noted that any aspect of any of the embodiments described herein can be used alone or in combination with one another.

What is claimed is:

1. A game controller comprising:
a handle;
a switch inside the handle; and
a user input device comprising:
a first end fixed inside the handle;
a second end positioned inside the handle adjacent to the switch; and
a user contact region exposed outside of the handle;
wherein in response to user force applied to the user contact region, the user input device is configured to deform and move the second end of the user input device to press the switch.

2. The game controller of claim 1, wherein in response to removal of user force to the user contact region, the user input device is configured to restore to a non-deformed position in which the second end of the user input device returns to a position adjacent to the switch.

3. The game controller of claim 1, wherein when the user input device is in a non-deformed position, a zero gap exists between an edge of the user contact region and an external surface of the game controller.

4. The game controller of claim 1, further comprising a hard-stop inside the handle configured to prevent further movement of the second end of the user input device after the second end presses the switch.

5. The game controller of claim 1, wherein the user input device comprises a blend of polycarbonate and acrylonitrile butadiene styrene (PC-ABS).

6. The game controller of claim 1, wherein the user input device comprises an L-shape.

7. The game controller of claim 1, wherein the user input device comprises a button.

8. The game controller of claim 7, wherein the button is located on a rear of the handle.

9. The game controller of claim 1, wherein a direction of user force is non-coaxial with a direct of force applied by the second end of the user input device to the switch.

10. The game controller of claim 9, wherein a component inside the handle prevents the switch from being positioned to allow the direction of user force to be coaxial with the force applied by the second end of the user input device to the switch.

11. The game controller of claim 10, wherein the component comprises a battery.

12. The game controller of claim 1, further comprising a second handle:
wherein:
the handle and the second handle are movable between a first position and a second position;
in the first position, the handle and the second handle are positioned to allow a mobile device to be positioned between the handle and the second handles; and
in the second position, inside edges of the handle and the second handle contact edges of the mobile device to secure the mobile device to the game controller.

13. A game controller comprising:
a handle;
a switch inside the handle; and
a user input device comprising:
a first end pinned inside the handle;
a second end positioned inside the handle adjacent to the switch; and
a user contact region exposed outside of the handle;
wherein in response to user force applied to the user contact region, the user input device is configured to pivot about the pinned first end to move the second end of the user input device to press the switch.

14. The game controller of claim 13, further comprising a spring configured to reposition the second end of the user input device adjacent to the switch in response to removal of user force to the user contact region.

15. The game controller of claim 13, wherein the switch is configured to provide a restorative force to reposition the second end of the user input device adjacent to the switch in response to removal of user force to the user contact region.

16. The game controller of claim 13, wherein the user input device comprises a button is located on a rear of the handle.

17. The game controller of claim 13, wherein a direction of user force is non-coaxial with a direct of force applied by the second end of the user input device to the switch.

18. The game controller of claim 17, wherein a component inside the handle prevents the switch from being positioned to allow the direction of user force to be coaxial with the force applied by the second end of the user input device to the switch.

19. The game controller of claim 18, wherein the component comprises a battery.

20. The game controller of claim 13, further comprising a second handle:
wherein:
the handle and the second handle are movable between a first position and a second position;
in the first position, the handle and the second handle are positioned to allow a mobile device to be positioned between the handle and the second handles; and
in the second position, inside edges of the handle and the second handle contact edges of the mobile device to secure the mobile device to the game controller.

21. A game controller comprising:
a handle;
a first circuit board inside the handle;
a second circuit board inside the handle; and
a joystick assembly comprising:
a movable stick;
circuitry configured to translate movement of the movable stick to an electrical signal; and
at least one electrical contact configured to convey the electrical signal;
wherein:
the first circuit board is positioned above the second circuit board;
the at least one electrical contact is coupled with the second circuit board; and
the first circuit board comprises an opening through which the joystick assembly passes.

22. The game controller of claim 21, wherein:
the joystick assembly further comprises skirting; and
the first circuit board comprises as second opening through which the skirting passes when the joystick is moved.

23. The game controller of claim 21, wherein a housing of the circuitry is located in the opening.

24. The game controller of claim 21, further comprising:
a switch inside the handle; and
a user input device comprising:
a first end supported inside the handle;
a second end positioned inside the handle adjacent to the switch, the second end being free to move to press the switch; and
a user contact region exposed outside of the handle.

25. The game controller of claim 24, wherein:
the first end is fixed inside the handle; and
in response to user force applied to the user contact region, the user input device is configured to deform and move the second end of the user input device to press the switch.

26. The game controller of claim 24, wherein:
the first end is pinned inside the handle; and
in response to user force applied to the user contact region, the user input device is configured to pivot about the pinned first end to move the second end of the user input device to press the switch.

27. The game controller of claim 24, wherein the user input device comprises a rear button.

28. The game controller of claim 21, further comprising a second handle:
wherein:
the handle and the second handle are movable between a first position and a second position;
in the first position, the handle and the second handle are positioned to allow a mobile device to be positioned between the handle and the second handles; and
in the second position, inside edges of the handle and the second handle contact edges of the mobile device to secure the mobile device to the game controller.
